(19) United States
(12) Patent Application Publication
(10) Pub. No.: US 2004/0133504 A1
(43) Pub. Date: Jul. 8, 2004

(54) System, method, and software for multi-party constrained optimization

(75) Inventor: Mukesh Dalal, Flower Mound, TX (US)

Correspondence Address: BAKER BOTTS L.L.P., 2001 ROSS AVENUE, SUITE 600, DALLAS, TX, 75201-2980, US

(73) Assignee: i2 Technologies US, Inc., a Delaware corporation

(21) Appl. No.: 10/739,979

(22) Filed: Dec. 17, 2003

Related U.S. Application Data
(62) Division of application No. 09/528,457, filed on Mar. 17, 2000.

(51) Int. Cl. G06F 17/60

(52) U.S. Cl. 705/37

(57) ABSTRACT

According to one embodiment, a computer-implemented method for multi-party constrained optimization is provided. The method includes accessing a first optimization problem corresponding to a first party to a negotiation, the first optimization problem including at least one first objective and one or more first constraints to which the first objective relates, and accessing a second optimization problem corresponding to a second party to the negotiation, the second optimization problem including at least one second objective and one or more second constraints to which the second objective relates. A first optimal value is determined for the at least one first objective considering the one or more first constraints for the first optimization problem, and a second optimal value is determined for the at least one second objective considering the one or more second constraints for the second optimization problem. A global solution to a global optimization problem is generated such that the global solution is consistent with the at least one first objective, the one or more first constraints, the at least one second objective, and the one or more second constraints. The global solution: (1) includes an option for resolving the computer-implemented multi-party negotiation; (2) represents a first excess between the global solution and the first optimal value and a second excess between the global solution and the second optimal value; and (3) is generated considering a fairness criterion specifying that the first excess is to minimally deviate from the first optimal value and that the second excess is to minimally deviate from the second optimal value considering the one or more first constraints and the one or more second constraints.

### RELATED APPLICATION

This application is a divisional of U.S. application Ser. No. 09/528,457 filed Mar. 17, 2000, currently pending.

### TECHNICAL FIELD OF THE INVENTION

This invention relates in general to the field of optimization and in particular to a system and method for multi-party constrained optimization.

### BACKGROUND

In the modern economic environment, an business or other party may engage in a planning activity involving one or more other businesses or parties. For example, an end product manufacturer and a component manufacturer may jointly plan the product manufacturer's procurement of components from the component manufacturer. These two parties may plan, along with a third technology partner, a joint marketing campaign involving all three of these parties. In a competitive business environment involving independent parties, each party naturally seeks to increase the economic value it derives from the planning activity, possibly to the detriment of other parties, subject to certain standard constraints or agreed upon rules. As a result, a party may be unwilling to share with other parties information relating to its internal operations, the values it associates with the planning activity, and any other proprietary information. Furthermore, parties and their pertinent information may change during the course of the negotiation. It is a goal to obtain a sufficiently optimal global solution that balances competing interests of multiple parties to a planning activity while satisfying their particular needs. Previous techniques have been inadequate in this environment.

### SUMMARY OF THE INVENTION

According to the present invention, problems and disadvantages associated with prior optimization techniques for multi-party planning may be reduced or eliminated.

According to one embodiment, a computer-implemented method for multi-party constrained optimization is provided. The method includes accessing a first optimization problem corresponding to a first party to a negotiation, the first optimization problem including at least one first objective and one or more first constraints to which the first objective relates, and accessing a second optimization problem corresponding to a second party to the negotiation, the second optimization problem including at least one second objective and one or more second constraints to which the second objective relates. A first optimal value is determined for the at least one first objective considering the one or more first constraints for the first optimization problem, and a second optimal value is determined for the at least one second objective considering the one or more second constraints for the second optimization problem. A global solution to a global optimization problem is generated such that the global solution is consistent with the at least one first objective, the one or more first constraints, the at least one second objective, and the one or more second constraints. The global solution: (1) includes an option for resolving the computer-implemented multi-party negotiation; (2) represents a first excess between the global solution and the first optimal value and a second excess between the global solution and the second optimal value; and (3) is generated considering a fairness criterion specifying that the first excess is to minimally deviate from the first optimal value and that the second excess is to minimally deviate from the second optimal value considering the one or more first constraints and the one or more second constraints.

Certain embodiments of the present invention may provide one or more technical advantages over previous techniques. In certain embodiments, the present invention makes possible multi-party constrained optimization by generating multi-party constrained optimization problems (MCOP) and providing optimal solutions to the MCOPs, while allowing the parties to the negotiation to keep their objectives and constraints from one another and, at least in part, from the broker. In addition, in certain embodiments, the present invention allows handling of stochastic or otherwise dynamic MCOPs, in which one or more parties, objectives, or constraints may change during the negotiation. In certain embodiments, the present invention includes schemes for achieving Pareto-optimal and globally fair solutions, and further allows the parties to participate in the filtering and selection of global solutions the broker generates, increasing the confidence the parties have in the broker and the operations used. These and other technical advantage make certain embodiments of the present invention well suited for modern multi-party planning environments. Other technical advantages may be readily apparent to those skilled in the art from the figures, description, and claims included herein.

### BRIEF DESCRIPTION OF THE DRAWINGS

FIG. 1 illustrates an example system for solving multi-party constrained optimization problems;

FIG. 2 illustrates an example multi-party constrained optimization problem;

FIG. 3 illustrates an example multi-stage process for solving multi-party constrained optimization problems;

FIG. 4 is an example table illustrating solutions to multi-party constrained optimization problem; and

FIG. 5 illustrates an example method for solving multi-party constrained optimization problems.

### DESCRIPTION OF EXAMPLE EMBODIMENTS

FIG. 1 illustrates an example system 10 to solve one or more multi-party constrained optimization problems (MCOP). System 10 includes multiple parties 12 that are coupled to and communicate information related the MCOPs with broker 14 using associated broker links 16, which may be any appropriate wireline, wireless, or other communications links. Parties 12 may be individuals, business, or any other suitable entities that are each planning an activity that involves one or more other parties 12. Broker 14 is preferably an impartial individual, business, or other entity appropriate to communicate with the parties 12 to facilitate their negotiation of a sufficiently optimal solution to one or more associated MCOPs. Parties 12 may select broker 14 through a preliminary negotiation or in another suitable manner. Parties 12 communicate with one another using one or more party links 18, which may be any suitable wireline, wireless, or other communications links. One or more rules governing the negotiation between parties 12, the authorized activities of broker 14, any commission payable to broker 14, and other suitable considerations may also be decided during a preliminary negotiation among parties 12, with or without interaction with broker 14.

As merely an example of a possible relationship between parties 12, if party 12a is a computer or other product manufacturer and party 12b is a computer chip or other component manufacturer, then parties 12a and 12b may jointly plan the procurement by party 12a of computer chips made by party 12b. For purposes of simplicity and ease of understanding, only two parties 12a and 12b are specifically discussed, although the present invention contemplates as many parties 12 as are appropriate. For example, if party 12c is a software manufacturer, then three parties 12a, 12b, and 12c may jointly plan a joint marketing campaign. Although two parties 12 are discussed, those skilled in the art will appreciate that the present invention is equally applicable to situations involving any number of parties 12, according to particular needs. Parties 12a and 12b may be referred to singly as party 12 and collectively as parties 12, as appropriate, and broker links 16a and 16b may be referred to singly as link 16 and collectively as links 16, as appropriate. A party 12 may be involved in two or more simultaneous negotiations with one or more other parties 12 relating to one or more planning activities, the two or more negotiations being interleaved in any appropriate manner, in whole or in part. Moreover, although a single broker 14 is discussed, multiple brokers 14 integral to or separate from one another may each interact with one or more parties 12, according to the present invention.

Each party 12 and each broker 14 is associated with one or more computers 20 at one or more locations. Each party 12 and broker 14 may include one or more human users of system 10, one or more suitable software components operating on computers 20, or a combination of human users and software components suitable to carry out a negotiation, in whole or in part. Computers 20 may each include an appropriate input device, such as a keypad, mouse, touch screen, microphone, or other suitable device to receive input from party 12 or broker 14. An output device may convey information associated with the operation of system 10, including visual or audio information, to party 12 or broker 14. Computer 20 may include suitable fixed or removable storage media, such as magnetic computer disks, CD-ROM, or any other media to receive input from and provide output to party 12 or broker 14. Computer 20 may further include a processor and associated volatile or non-volatile memory to execute instructions and to manipulate information according to the operation of system 10. A party 12 may share one or more computers 20 and other resources with one or more other parties 12 or broker 14.

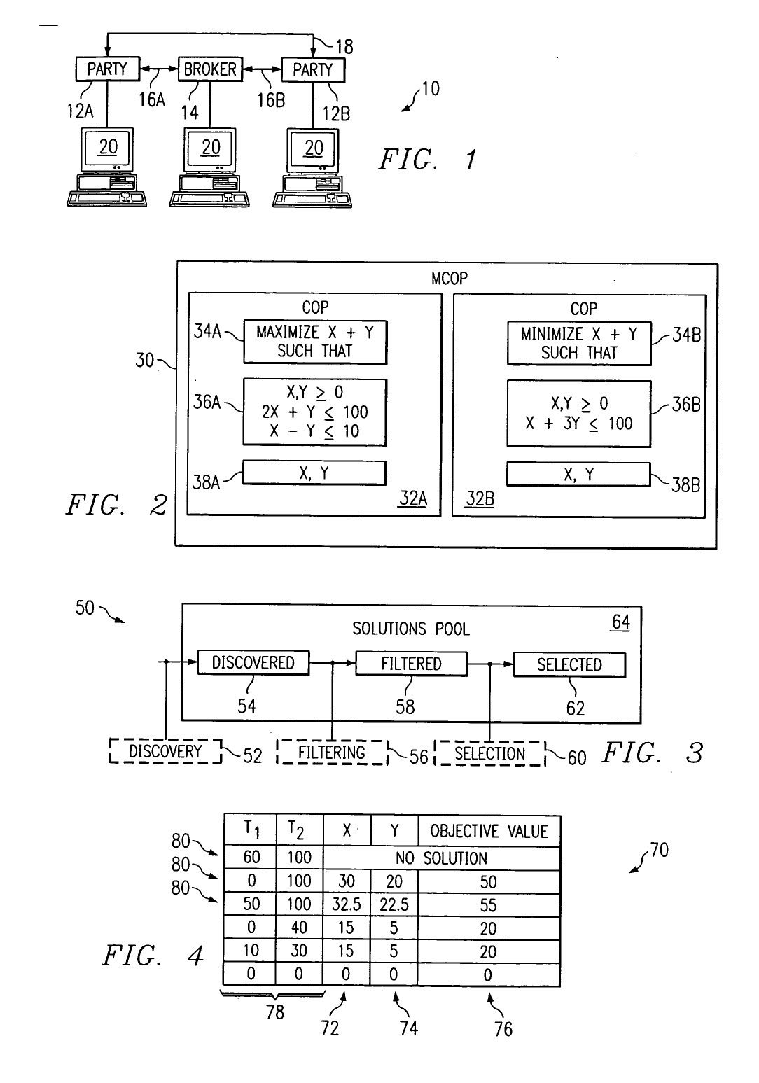

In a multi-party planning situation, each party 12 will in general have its own constrained optimization problem (COP): to maximize one or more objective functions with respect to one or more constrained decision variables. If the COPs of parties 12 share one or more decision variables, as is typical, then the COPs of parties 12 are not independent of one another. FIG. 2 illustrates an example MCOP 30 involving parties 12a and 12b with corresponding COPs 32a and 32b, respectively. Each of the COPs 32 includes one or more objective functions 34 and one or more constraints 36 relating to a set of one or more global decision variables 38. Each COP 32 may be deterministic, stochastic (involving one or more random variables), or any appropriate combination of these. Rather than being explicitly formulated, one or more COPs 32 may be implicitly expressed or otherwise generated, for example, according to operation of computer software. An optimal solution to MCOP 30 includes an assignment of a value to each variable 38, such that all of the objectives 34 are optimized and all of the constraints 36 are satisfied.

Moreover, it is a goal of multi-party constrained optimization (MCO) according to the present invention to determine at least one fair Pareto-optimal global solution to non-independent optimization problems of parties 12 that parties 12 transmit to broker 14 using links 16. In one embodiment, these transmitted optimization problems may include all or only a portion of the objectives 34, constraints 36, and variables 38 of COPs 32. As a result, party 12 may withhold selected information from broker 14, in addition to refusing to share it with other parties 12. A global solution may be defined as a union of mutually consistent solutions to the transmitted optimization problems of all parties 12 to the negotiation. A global solution may be considered Pareto-optimal if no global solution is better with respect to any objective without also being worse with respect to at least one other objective. A global solution may be deemed fair if it does not provide an additional advantage to any party 12, according to one or more suitable criteria, beyond any rules parties 12 have previously agreed upon.

In the particular case in which all COPs 32 share the same objectives 34, MCO reduces to traditional single party constrained optimization (CO), a simpler problem. This most often arises when parties 12 are different organizations in a single business enterprise. For example, planning a computer network expansion within an enterprise may require involvement of finance, information technology, development, and other departments within the enterprise. It is often challenging to identify common objectives 34, an inability to do so often reflecting one or more deeper management problems that must be resolved at the enterprise level.

MCO becomes more difficult when the parties 12 do not trust each other or are otherwise unwilling to share their COPs 32 with one another. This is typical when the parties 12 are independent business enterprises and their COPs 32 reflect proprietary information for which sharing could be harmful to the enterprises. As described above, the present invention provides an optimal solution to MCOP 30 without requiring that parties 12 share their respective COPs 32 or portions thereof with one another, which provides an important technical advantage. In addition, also as described above, parties 12 need not share their entire COPs 32 even with broker 14, instead transmitting to broker 14 suitable optimization problems that may include only portions of COPs 32. Furthermore, as described more fully below, the present invention supports dynamic MCO (DMCO), in which one or more parties 12 or one or more aspects of their COPs 32, such as one or more objectives 34 or one or more constraints 36, may change during the negotiation process.

In the particular example MCOP illustrated in FIG. 2, COPs 32a and 32b for parties 12a and 12b, respectively, reflect that there are two global decision variables 38 X and Y; that there is one objective 34 for each party 12 (“maximize X+Y” for party 12a and “minimize X+Y” for party 12b); and that there are multiple constraints 36 for each party 12. Note that the objective 34 “minimize X+Y” may be considered identical to the objective 34 “maximize −(X+Y)” if a corresponding threshold or other value (described more fully below) is also consistently treated as oppositely signed. Since objectives 34a and 34b in this particular example are opposites of one another, every solution is Pareto-optimal. Although two extreme solutions exist in this example (X=0, Y=0 and X=32.5, Y=22.5) and define the ranges of X (0, 32.5) and Y (0, 22.5), one cannot specify all the solutions merely by indicating the ranges of these variables 38, because the optimal values of X and Y depend on one another. Further, a fair solution to the MCOP 30 will depend upon any rules that the parties 12 have previously agreed upon, as described more fully below.

In one embodiment, system 110 implements a brokered multi-party constrained optimization (BOMCO) technique involving parties 12 and broker 14 to obtain one or more solutions to MCOP 30. FIG. 3 illustrates an example BOMCO process 50. involving three stages of negotiation between broker 14 and each party 12. The stages of BOMCO process 50 may include, singly or in any appropriate combination, without limitation: (1) a solution discovery stage 52 to generate a set of one or more global solutions 54; (2) a solution filtering stage 56 to discard any unacceptable discovered global solutions 54 and generate a set of one or more filtered solutions 58, and (3) a solution selection stage 60 to select a single global solution 54 from among the filtered solutions 58 and generate a set of one or more selected solutions 62. The set of one or more global solutions 54 that have been discovered but not discarded are collectively referred to as the solutions pool 64, whether or not filtered or selected.

In one embodiment, filtering stage 56 and selection stage 60 are optional. For example, and not by way of limitation, filtering of an empty solutions pool 64 is not possible and is therefore inappropriate. One or more of the above stages 52, 56, and 60 may be repeated as appropriate. For example, and not by way of limitation, discovery stage 52 may be repeated one or more times if the filtering stage 56 results in all of the discovered global solutions 54 being discarded. The present invention contemplates discovery stage 52, filtering stage 56, selection stage 60, and any other suitable stages each occurring any suitable number of times and occurring in any suitable order during the negotiation, as appropriate and according to particular needs.

Discovery stage 52 may occur in multiple rounds, each generating one global solution 54 to the MCOP 30. In one embodiment, each round of the discovery stage 52 involves at least: (1) problem transmission from parties 12 to broker 14, (2) generation of at least one global solution 54 at broker 14 according to the problems transmitted, and (3) solution transmission from broker 14 to parties 12. For problem transmission, each party 12 transmits an optimization problem to the broker 14 that includes at least one objective 34 of COP 32. Together with or separate from their optimization problems, parties 12 each also communicates a threshold or other suitable value relating to each transmitted objective 34. Broker 14 may, instead or in addition to receiving a threshold value from a party 12, generate an optimal value according the optimization problem for party 12, to which solution values will be compared. As described above, the optimization problem transmitted from party 12 to broker 14 may but is not required to be the same as its COP 32. For solution generation, the broker 14 generates a linear program (LP) or other suitable formulation of the global optimization problem and then uses an associated LP solver or other solution generator to generate at least one global solution 54 to the global optimization problem. For solution transmission, broker 14 either transmits the global solution 54 to each party 12 or informs the parties 12 that no feasible global solution 54 could be discovered. Termination of the discovery stage is determined according to previously agreed upon rules governing the negotiation, for example, after a specified number of global solutions 54 has been generated or one or more other criteria have been satisfied.

In one embodiment, the global solution 54 transmitted to any party 12 should solve the optimization problem of that party 12 such that the resulting value of each of the transmitted objectives 34 is not less than the corresponding threshold or otherwise inconsistent with the transmitted value to which it relates. In addition, global solutions 54 transmitted to the parties 12 should be mutually consistent and, preferably, globally Pareto-optimal and fair. In one embodiment, it is undesirable to settle for a particular global solution 54 when another global solution 54 can do better than merely meeting transmitted thresholds or otherwise being consistent with transmitted values relating to objectives 34. Broker 14 may use one or more agreed upon fairness criteria to fairly distribute such excess. In one embodiment, such criteria may include but are not limited to, in any suitable combination: (1) an equal distribution criterion, (2) a geometric distribution criterion, (3) a weighted distribution criterion, (4) a weighted geometric distribution criterion, and (5) a minimum deviation from optimal criterion. After using one or more of these fairness criteria, broker 14 may also perform one or more Pareto-optimality passes to achieve suitable Pareto-optimality (improving one or more objectives 34 of one party 12 without violating the objectives 34 of another party 12) based on a fixed or other suitable relative ranking of parties 12 themselves or that parties 12 have supplied as to the importance of each objective 34. The resulting global solution 54 is guaranteed to be Pareto-optimal.

Using an equal distribution criterion, the values of objectives 34 for parties 12 must exceed their corresponding thresholds by the same amount. For example, if the thresholds for parties 12a and 12b are (10, 50), then both (20, 60) and (100, 140) are deemed fair, but (20, 100) is not. Using a geometric distribution criterion, the values of objectives 34 must exceed their corresponding thresholds by the same fraction. As an example, if the thresholds for parties 12a and 12b are (10, 50), then both (20, 100) and (15, 75) are deemed fair, but (20, 60) is not. Using a weighted distribution criterion, a previously agreed upon, assigned, or any other weight (typically a positive number) is associated with each party 12. The differences between the values of objectives 34 and the corresponding thresholds must be in the same ratio as their weights. For example, if the weights for parties 12a and 12b are (2, 1) and their thresholds are (10, 50), then both (20, 55) and (100, 95) are considered fair, but (20, 60) is not. Using a weighted geometric distribution criterion, the ratios of the values of objectives 34 to associated thresholds must be the same as their weights. As an example, if the weights for parties 12a and 12b are (3, 2) and the thresholds are (10, 50), then both (30, 100) and (60, 200) are fair, but (20, 100) is not. Using a minimum deviation from optimal criterion, instead of using thresholds, the optimal values of objectives 34 (which broker 14 may generate according to the transmitted optimization problems) are used while considering all the transmitted constraints 36 that relate to the objectives 34. Although these criteria are described with respect to thresholds, analogous criteria may be used with respect to optimal or other values relating to objectives 34.

There are several effective approaches to filtering solutions pool 64 at filtering stage 56. In one embodiment, these approaches include, for example and not by way of limitation: (1) veto—any global solution 54 vetoed by any party 12 is discarded; (2) Pareto-optimal ranking—parties 12 rank global solutions 54 and all global solutions 54 lacking Pareto-optimal ranking are discarded; (3) optimal weighted preferences—each party 12 provides a value for each global solution 54 indicating the relative strength of its preference for that global solution 54, broker 14 determines all the global solutions 54 that maximize or otherwise optimize the total weight, and remaining global solutions 54 are discarded; and (4) mixed—for example, veto and optimal weighted preferences approaches may be mixed by treating any negative weights as vetoes. For the optimal weighted preference approach, if a fairness criterion used during discovery stage 52 incorporates different weights for different parties 12, then the weights are preferably considered. The present invention contemplates combining two or more of these or any other suitable approaches as appropriate. As for other aspects of the negotiation, one or more parties 12, broker 14, or parties 12 and broker 14 collectively will preferably have previously agreed on a filtering approach to be used.

There are several approaches for selecting a solution from filtered solutions 58 at selection stage 60. In one embodiment, an auction may be performed in which each party 12 bids on the right to select a solution. The highest bidding party 12, who then selects the solution, pays money to other parties 12 according to the second highest bid. For example, the winning party 12 may pay the difference between its winning bid and the second highest bid, or some suitable factor multiplied by that difference. This money is fairly distributed among the other parties 12 according to an appropriate distribution scheme, for example, to parties 12 in proportion to their bids. Alternatively, as just an example, broker 14 may randomly select one filtered solution 58. If a fairness criterion used during discovery stage 52 incorporated different weights for parties 12, then the weights may be considered in selecting a filtered solution 58 at selection stage 60. As for other aspects of the negotiation, one or more parties 12, broker 14, or parties 12 and broker 14 will preferably have previously agreed on a selection approach to be used during selection stage 60.

Continuing the particular example involving parties 12a and 12b, suppose that parties 12a and 12b have agreed on the following negotiation rules for use during the BOMCO process: (1) the negotiation will include only the discovery stage 52 (possibly involving multiple rounds); (2) the negotiation will end after one global solution 54 is discovered; (3) any excess will be equally distributed between parties 12a and 12b; and (4) the rounds of discovery stage 52 may differ only with respect to the thresholds or other values that parties 12 transmit, not with respect to the objectives 34 or constraints 36. In the first round of discovery stage 52, parties 12a and 12b transmit to broker 14 their respective optimization problems, along with thresholds or other suitable values that correspond to objectives 34 included in the optimization problems. As described above, broker 14 may, instead or in addition to receiving a threshold from party 12, generate an optimal value according the optimization problem for the party 12, to which a solution value for party 12 are compared. In a particular embodiment, transmitted optimization problems are COPs 32a and 32b shown in FIG. 2.

Using thresholds for purpose of explanation, given a first threshold T₁ for party 12a and a second threshold T₂ for party 12b, the broker 14 may generate and solve the following linear program for which one goal is to maximize any excess and to distribute it equally between parties 12a and 12b such that each party 12 will get E₁=E₂=E of the excess:

Maximize E such that 2X+Y≦100,

X−Y≦10,

X+3Y≦100,

X+Y−E≧T₁,

X+Y+E≦T₂,

X≧0, and

Y≧0

Those skilled in the art will appreciate that this formulation is merely example and that the present invention is intended to encompass any appropriate linear program or other global optimization problem reflecting information transmitted from parties 12 to broker 14. Using this formulation, broker 14 generates a global solution 54 according to the thresholds received from parties 12. If parties 12 each transmit more than one threshold, for example, a primary or more desirable threshold and a secondary or less desirable threshold, broker 14 may generate more than one corresponding global solution 54. The present invention contemplates the parties 12 transmitting any number of thresholds or other values to broker 14 and broker 14 generating in response multiple corresponding global solutions 54, serially, substantially simultaneously, or in any other appropriate manner.

FIG. 4 is a table 70 containing example values 72 and 74 of variables 38 X and Y, respectively, and an objective value 76 (the determined global solution 54) for several threshold pairs 78 for this particular example involving parties 12a and 12b. Under the example rules described above, and assuming the thresholds pairs 78 are transmitted and operated on at broker 14 in the order listed in table 70 during discovery stages 52 of multiple negotiations 80, the objective values 76 are determined as shown. In this example, objective values 76 have a range (0, 55), which are the global minimum and maximum, respectively, for objective values 76 among all of the global solutions 54.

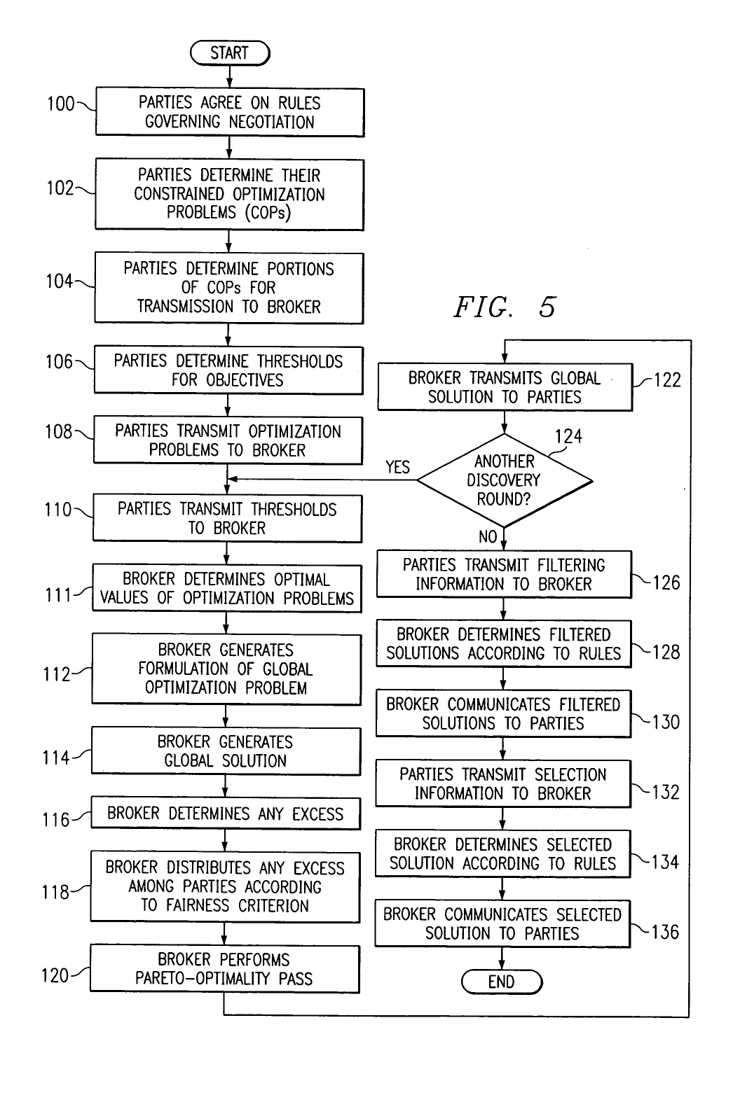

FIG. 5 is a flowchart illustrating an example method of solving an MCOP 30. The method begins at step 100, where the two or more parties 12 to the negotiation agree on rules governing the negotiation, with or without the participation of broker 14. These rules may be standardized rules, rules customized for the particular parties 12, or any suitable combination of these. In one embodiment, agreeing on the rules governing the negotiation may include agreeing on, in any appropriate combination and without limitation: (1) the identity of broker 14 and any issues relating to the participation of broker 14, for example, compensation of broker 14; (2) whether Pareto-optimality will be sought with respect to one or more global solutions 54, (3) how the end of discovery stage 52 is to be determined, (4) the number of rounds for discovery stage 52, (5) the number of global solutions 54 to be generated in each round of discovery stage 52, (6) whether and how one or more rules may vary from round to round in discovery stage 52, (7) one or more fairness criteria governing distribution of any excess, (8) whether and how one or more weights are to be associated with each party 12 for distributing any excess according to the fairness criterion used, (9) whether broker 14 will perform one or more Pareto-optimality passes, (10) whether one or more filtering stages 56 will be used, (11) a filtering approach to be used at filtering stage 56 and any rules associated with that filtering approach, (12) whether one or more selection stages 60 will be used, (13) a selection approach to be used at selection stage 60 and any rules associated with that selection approach, and (14) any other issues appropriate for agreement among the parties 12.

At step 102, parties 12 determine their COPs 32, including determining one or more objectives 34 and one or more constraints 36 relating in some suitable manner to one or more global variables 38. At step 104, parties 12 determine their optimization problems for transmission to broker 14. As described above, the optimization problem for a party 12 may include any suitable portion of corresponding COP 32 that includes at least one objective 34. At step 106, parties 12 determine one or more thresholds or other values for transmission to broker 14, each value relating to a particular objective 34 in the optimization problem. Steps 104 and 106 may occur serially, in any relative order, or substantially simultaneously.

In one embodiment, discovery stage 52 begins at step 108, where the parties 12 transmit the respective optimization problems to broker 14. At step 110, each party 12 transmits to broker 14 one or more thresholds or other values relating to the objectives 34 within its transmitted optimization problem. For each party 12 to the negotiation, steps 108 and 110 may occur substantially simultaneously or in any appropriate order relative to one another. Also, steps 108 and 110 for party 12 may occur substantially simultaneously with or in any suitable order relative to steps 108 and 110 for any other party 12 to the negotiation. Further, step 108 may follow step 104 and step 110 may follow step 106 for one or more of the parties 12. The present invention contemplates steps 104 through 110 occurring in any suitable order for one or more parties 12.

At step 112, broker 14 generates a linear program or other suitable formulation of the global optimization problem according to the multiple optimization problems and values received from parties 12 and, at step 114, generates a corresponding global solution 54. As part of or separate from discovering the global solution 54, broker 14 determines whether any excess exists at step 116 and, at step 118, distributes any such excess among parties 12 according to one or more previously agreed upon or other suitable fairness criteria. Broker 14 may also perform one or more Pareto-optimality passes at step 120, as part of or separate from determining the global solution 54, to achieve Pareto-optimality. Broker 14 transmits global solution 54 to parties 12 at step 122, substantially simultaneously or in any relative order. In one embodiment, if a next round of discovery stage 52 is to be performed at step 124, the method returns to step 110, where parties 12 may transmit new thresholds or other values to the broker 14. Otherwise, discovery stage 52 ends, filtering stage 56 may begin if desired, and the method proceeds to step 126, where parties 12 transmit suitable filtering information to broker 14 according to a previously agreed upon or other filtering approach.

At step 128, broker 14 uses the selected filtering approach to determine one or more filtered solutions 58 according to appropriate rules. Broker 14 then transmits to, identifies for, or otherwise communicates to parties 12 the filtered solutions 58 at step 130 and filtering stage 56 ends. Selection stage 60 may begin at step 132, where the parties 12 transmit selection information to broker 14 according to a previously agreed upon or other suitable selection approach. At step 134, broker 14 uses the appropriate selection approach to determine a selected solution 62 according to appropriate rules. Broker 14 then transmits to, identifies for, or otherwise communicates to parties 12 the selected solution 62 at step 136, selection stage 60 ends, and the method ends.

As has been described above, the present invention contemplates discovery stage 52, filtering stage 56, and selection stage 60 occurring any suitable number of times and each such stage 52, 56, or 60 occurring in any appropriate order relative to any other such stage 52, 56, or 60. For example only, and not by way of limitation, parties 12 may agree that filtering stage 56 and selection stage 60 will occur after a specified number of global solutions 54 are discovered at discovery stage 52, while allowing for the possibility of another discovery stage 52 if the results of such filtering and selection are considered inadequate for some reason. Furthermore, the present invention contemplates one or more parties 12 changing during the negotiation, one or more aspects of their COPs 32 or their associated objectives 34, constraints 36, transmitted optimization problems, or thresholds or other values changing during the negotiation, or any other suitable aspect of an MCO scenario changing during the negotiation. The present invention is highly flexible to accommodate these changes, for example, allowing one or more stages 52, 56, or 60 to be repeated as appropriate and providing appropriate safeguards such that the interests of all parties 12 may be served.

Although the present invention has been described with several embodiments, a plethora of changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A computer-implemented method for multi-party constrained optimization, the method performed using a computer system comprising one or more processing units and one or more memory units, the method comprising:
using the computer system, accessing a first optimization problem corresponding to a first party to a negotiation, the first optimization problem comprising at least one first objective and one or more first constraints-to which the first objective relates;
using the computer system, accessing a second optimization problem corresponding to a second party to the negotiation, the second optimization problem comprising at least one second objective and one or more second constraints to which the second objective relates;
using the computer system, determining a first optimal value for the at least one first objective considering the one or more first constraints for the first optimization problem;
using the computer system, determining a second optimal value for the at least one second objective considering the one or more second constraints for the second optimization problem; and
using the computer system, generating a global solution to a global optimization problem such that the global solution is consistent with the at least one first objective, the one or more first constraints, the at least one second objective, and the one or more second constraints, the global solution:
comprising an option for resolving the computer-implemented multi-party negotiation;
representing a first excess between the global solution and the first optimal value and a second excess between the global solution and the second optimal value; and
being generated considering a fairness criterion specifying that the first excess is to minimally deviate from the first optimal value and that the second excess is to minimally deviate from the second optimal value considering the one or more first constraints and the one or more second constraints.

2. The method of claim 1, further comprising receiving the first optimization problem from the first party, the first optimization problem comprising at least a portion of a constrained optimization problem (COP) for the first party, the COP comprising at least the first objective.

3. The method of claim 2, wherein the COP further comprises at least one constraint relating to one or more global variables.

4. The method of claim 1, wherein the global optimization problem comprises a linear programming (LP) problem.

5. The method of claim 1, further comprising:
accessing one or more first threshold values for the first party;
accessing one or more second threshold values for the second party; and
generating the global solution consistent with the one or more first threshold values and the one or more second threshold values.

6. The method of claim 5, wherein the first objective value exceeds the one or more first threshold values accessed for the first party and the second objective value exceeds the one or more second threshold values accessed for the second party.

7. The method of claim 1, wherein the global solution is generated as a Pareto-optimal solution.

8. The method of claim 1, further comprising:
communicating one or more global solutions to the first party and the second party;
receiving filtering information from the first party and the second party;
using the filtering information to determine one or more filtered global solutions from among the global solutions according to a filtering approach.

9. The method of claim 8, wherein the filtering approach is selected from the group consisting of:
a veto approach;
a Pareto-optimal ranking approach;
an optimal weighted preferences approach; and
a mixed approach combining two or more of the above.

10. The method of claim 1, further comprising:
communicating one or more global solutions to the first party and the second party;
receiving selection information from the first party and the second party;
using the selection information to determine a selected global solution from among the communicated global solutions according to a selection approach.

11. The method of claim 10, wherein the selection approach is selected from the group consisting of:
an auction approach; and
a random selection approach.

12. The method of claim 10, wherein the one or more communicated global solutions comprise a filtered global solution determined from among one or more global solutions according to a filtering approach using filtering information received from the first and second parties.

13. The method of claim 1, further comprising mediating at least a portion of a negotiation between the first party and a third party substantially simultaneously with the negotiation between the first party and the second party.

14. A computer-implemented system for multi-party constrained optimization, the system comprising one or more processing units and one or more memory units collectively operable to:
access a first optimization problem corresponding to a first party to a negotiation, the first optimization problem comprising at least one first objective and one or more first constraints-to which the first objective relates;
access a second optimization problem corresponding to a second party to the negotiation, the second optimization problem comprising at least one second objective and one or more second constraints to which the second objective relates;
determine a first optimal value for the at least one first objective considering the one or more first constraints for the first optimization problem;
determine a second optimal value for the at least one second objective considering the one or more second constraints for the second optimization problem; and
generate a global solution to a global optimization problem such that the global solution is consistent with the at least one first objective, the one or more first constraints, the at least one second objective, and the one or more second constraints, the global solution:
comprising an option for resolving the computer-implemented multi-party negotiation;
representing a first excess between the global solution and the first optimal value and a second excess between the global solution and the second optimal value; and
being generated considering a fairness criterion specifying that the first excess is to minimally deviate from the first optimal value and that the second excess is to minimally deviate from the second optimal value considering the one or more first constraints and the one or more second constraints.

15. The system of claim 14, further operable to receive the first optimization problem from the first party, the first optimization problem comprising at least a portion of a constrained optimization problem (COP) for the first party, the COP comprising at least the first objective.

16. The system of claim 15, wherein the COP further comprises at least one constraint relating to one or more global variables.

17. The system of claim 14, wherein the global optimization problem comprises a linear programming (LP) problem.

18. The system of claim 14, further operable to:
access one or more first threshold values for the first party;
access one or more second threshold values for the second party; and
generate the global solution consistent with the one or more first threshold values and the one or more second threshold values.

19. The system of claim 18, wherein the first objective value exceeds the one or more first threshold values accessed for the first party and the second objective value exceeds the one or more second threshold values accessed for the second party.

20. The system of claim 14, wherein the global solution is generated as a Pareto-optimal solution.

21. The system of claim 14, further operable to:
communicate one or more global solutions to the first party and the second party;
receive filtering information from the first party and the second party;
use the filtering information to determine one or more filtered global solutions from among the global solutions according to a filtering approach.

22. The system of claim 21, wherein the filtering approach is selected from the group consisting of:
a veto approach;
a Pareto-optimal ranking approach;
an optimal weighted preferences approach; and
a mixed approach combining two or more of the above.

23. The system of claim 14, further operable to:
communicate one or more global solutions to the first party and the second party;
receive selection information from the first party and the second party;
use the selection information to determine a selected global solution from among the communicated global solutions according to a selection approach.

24. The system of claim 23, wherein the selection approach is selected from the group consisting of:
an auction approach; and
a random selection approach.

25. The system of claim 23, wherein the one or more communicated global solutions comprise a filtered global solution determined from among one or more global solutions according to a filtering approach using filtering information received from the first and second parties.

26. The system of claim 14, further operable to mediate at least a portion of a negotiation between the first party and a third party substantially simultaneously with the negotiation between the first party and the second party.

27. Software for multi-party constrained optimization, the software embodied in a computer-readable medium and operable to, when executed using a computer system comprising one or more processing units and one or more memory units:
access a first optimization problem corresponding to a first party to a negotiation, the first optimization problem comprising at least one first objective and one or more first constraints-to which the first objective relates;
access a second optimization problem corresponding to a second party to the negotiation, the second optimization problem comprising at least one second objective and one or more second constraints to which the second objective relates;
determine a first optimal value for the at least one first objective considering the one or more first constraints for the first optimization problem;
determine a second optimal value for the at least one second objective considering the one or more second constraints for the second optimization problem; and
generate a global solution to a global optimization problem such that the global solution is consistent with the at least one first objective, the one or more first constraints, the at least one second objective, and the one or more second constraints, the global solution:
comprising an option for resolving the computer-implemented multi-party negotiation;
representing a first excess between the global solution and the first optimal value and a second excess between the global solution and the second optimal value;
being generated considering a fairness criterion specifying that the first excess is to minimally deviate from the first optimal value and that the second excess is to minimally deviate from the second optimal value considering the one or more first constraints and the one or more second constraints.

28. The software of claim 27, further operable to receive the first optimization problem from the first party, the first optimization problem comprising at least a portion of a constrained optimization problem (COP) for the first party, the COP comprising at least the first objective.

29. The software of claim 28, wherein the COP further comprises at least one constraint relating to one or more global variables.

30. The software of claim 27, wherein the global optimization problem comprises a linear programming (LP) problem.

31. The software of claim 27, further operable to:
access one or more first threshold values for the first party;
access one or more second threshold values for the second party; and
generate the global solution consistent with the one or more first threshold values and the one or more second threshold values.

32. The software of claim 31, wherein the first objective value exceeds the one or more first threshold values accessed for the first party and the second objective value exceeds the one or more second threshold values accessed for the second party.

33. The software of claim 27, wherein the global solution is generated as a Pareto-optimal solution.

34. The software of claim 27, further operable to:
communicate one or more global solutions to the first party and the second party;
receive filtering information from the first party and the second party;
use the filtering information to determine one or more filtered global solutions from among the global solutions according to a filtering approach.

35. The software of claim 34, wherein the filtering approach is selected from the group consisting of:
a veto approach;
a Pareto-optimal ranking approach;
an optimal weighted preferences approach; and
a mixed approach combining two or more of the above.

36. The software of claim 27, further operable to:
communicate one or more global solutions to the first party and the second party;
receive selection information from the first party and the second party;
use the selection information to determine a selected global solution from among the communicated global solutions according to a selection approach.

37. The software of claim 36, wherein the selection approach is selected from the group consisting of:
an auction approach; and
a random selection approach.

38. The software of claim 36, wherein the one or more communicated global solutions comprise a filtered global solution determined from among one or more global solutions according to a filtering approach using filtering information received from the first and second parties.

39. The software of claim 27, further operable to mediate at least a portion of a negotiation between the first party and a third party substantially simultaneously with the negotiation between the first party and the second party.

40. A computer-implemented system for multi-party constrained optimization, comprising:
means for accessing a first optimization problem corresponding to a first party to a negotiation, the first optimization problem comprising at least one first objective and one or more first constraints-to which the first objective relates;
means for accessing a second optimization problem corresponding to a second party to the negotiation, the second optimization problem comprising at least one second objective and one or more second constraints to which the second objective relates;
means for using the computer system, determining a first optimal value for the at least one first objective considering the one or more first constraints for the first optimization problem;
means for determining a second optimal value for the at least one second objective considering the one or more second constraints for the second optimization problem; and
means for generating a global solution to a global optimization problem such that the global solution is consistent with the at least one first objective, the one or more first constraints, the at least one second objective, and the one or more second constraints, the global solution:
comprising an option for resolving the computer-implemented multi-party negotiation;
representing a first excess between the global solution and the first optimal value and a second excess between the global solution and the second optimal value; and
being generated considering a fairness criterion specifying that the first excess is to minimally deviate from the first optimal value and that the second excess is to minimally deviate from the second optimal value considering the one or more first constraints and the one or more second constraints.
